(19) United States
(12) Patent Application Publication
(10) Pub. No.: US 2025/0346759 A1
(43) Pub. Date: Nov. 13, 2025

(54) ELASTOMER BINDERS USING NANOPARTICLES IN POLYMER MIXTURES

(71) Applicant: The Government of the United States of America, as represented by the Secretary of the Navy, Arlington, VA (US)

(72) Inventors: Peter H. Mott, Washington, DC (US); Charles M. Roland, Waldorf, MD (US); Nickolaus K. Weise, Alexandria, VA (US); Brian P. Mason, Monterey, CA (US)

(73) Assignee: The Government of the United States of America, as represented by the Secretary of the Navy, Arlington, VA (US)

(21) Appl. No.: 19/203,272

(22) Filed: May 9, 2025

Related U.S. Application Data
(60) Provisional application No. 63/644,591, filed on May 9, 2024.

(51) Int. Cl. C08L 75/08; C08K 3/04; C08K 3/36

(52) U.S. Cl. CPC C08L 75/08; C08K 3/04; C08K 3/36; C08K 2201/011

(57) ABSTRACT

Disclosed herein is a composition having: a continuous phase of a first polymer, a discontinuous phase of a second polymer embedded in the continuous phase, and particles of a filler material in the continuous phase, the discontinuous phase, or both. The first polymer and the second polymer are immiscible. The discontinuous phase viscosity is higher than the continuous phase viscosity.

### REFERENCE TO RELATED APPLICATIONS

This application claims the benefit of U.S. Provisional Application No. 63/644,591, filed on May 9, 2024. The provisional application and all other publications and patent documents referred to throughout this nonprovisional application are incorporated herein by reference.

### TECHNICAL FIELD

The present disclosure is generally related to elastomer binders.

### DESCRIPTION OF THE RELATED ART

Rubbery binders provide the essential mechanical integrity of an aggregate mixture. For example, hydroxy-terminated polybutadiene (HTPB), is a common binder used in many different sorts of aggregated mixtures, in a variety of applications. However, HTPB requires a trade-off between the low viscosity of its oligomer (essential for processing), and final crosslinked stiffness (necessary for storage and use). In the end, this trade-off compromises the mechanical integrity of the final application.

While mixing of an aggregate mixture, the binder must enable flow of the granules, during which the shear strain in the binder is expected to be on the order of 1000%. However, after the curing during storage and service, the strain is quite low (<10%), which arises from quasi-static loading, handling perturbations, thermal stresses from temperature changes, etc. In particular, decreasing the temperature will generate negative pressures (i.e., tensile mean normal stress) arising from the rubber being confined between larger solid particles. The negative pressure to form a void is (Gent et al., Proceedings of the Royal Society of London A 249, 195-205 (1959); Gent, “Rubber Elasticity: Basic Concepts and Behavior,” in “The Science and Technology of Rubber,” 4th edition, B. Erman, J. E. Mark, and C. M. Roland, eds. (Elsevier) 2013)

$$- P = \frac{5}{2} G$$

where G is the shear modulus. The pressure generated from a temperature change is found by

$$P = B αΔ T$$

where B is the bulk modulus, α the thermal expansion coefficient, and ΔT the temperature change (negative pressures arises from a temperature decrease). Setting the two equations equal gives

$$Δ T = - \frac{5 G}{2 α B}$$

Using typical values for a soft rubber (B=1700 M Pa, G=0.5 M Pa, α=10⁻⁴ K⁻¹), this equation reveals that voids will initiate when the temperature drop is greater than 7.4 K, in a closed interstice. (For partially confined rubber, the temperature drop to initiate voids will be somewhat larger.) Once formed, voids initiate cracks that grow with additional thermal cycling and other handling stresses, decreasing strength, and other losses of properties. Thus, while a soft polymer binder is needed to minimize the temperature rise and enable easy packing during processing, this attribute is at odds with the high stiffness needed to prevent void formation and crack growth.

### SUMMARY OF THE INVENTION

Disclosed herein is a composition comprising: a continuous phase comprising a first polymer; a discontinuous phase comprising a second polymer embedded in the continuous phase; and particles of a filler material in the continuous phase, the discontinuous phase, or both. The first polymer and the second polymer are immiscible. The continuous phase has a first viscosity, and the discontinuous phase has a second viscosity higher than the first viscosity.

Also disclosed herein is a method comprising: providing a first polymer, a second polymer, and particles of a filler material; combining the first polymer, the second polymer, or both with the particles; and mixing the first polymer and the second polymer to form a composition. The composition comprises: a continuous phase comprising the first polymer, a discontinuous phase comprising the second polymer embedded in the continuous phase, and the particles in the continuous phase, the discontinuous phase, or both. The first polymer and the second polymer are immiscible. The continuous phase has a first viscosity, and the discontinuous phase has a second viscosity higher than the first viscosity.

### BRIEF DESCRIPTION OF DRAWINGS

A more complete appreciation will be readily obtained by reference to the following Description of the Example Embodiments and the accompanying drawings.

FIG. 1 shows a model system chemistry.

FIG. 2 shows the phase structure after mixing two incompatible polymers A (=PTHF) and B (=PEG), determined by the viscosity ratio η_{A}/η_{B} of the two components, as a function of composition (Avgeropoulos et al., Rubber Chemistry and Technology 49, 93-104 (1976)).

FIG. 3 shows steady-state shear viscosity of neat and silica-filled samples of PTHF.

FIG. 4 shows steady-state shear viscosity of neat and silica- and diamond-filled samples of PEG.

FIG. 5 shows storage and loss moduli of three SiO₂ systems, with the average concentration fixed to 10%: (1) “all-in PTHF”—20% SiO₂ in PTHF and 0% in PEG; (2) “uniform”—both PTHF and PEG have 10% SiO₂; and (3) “all-in-PEG”—0% SiO₂ in PTHF and 20% in PEG. The measurement frequency was 3 rad/s.

FIG. 6 shows a comparison of the storage moduli of the PTHF-PEG polymer mixtures, as measured in an amplitude sweep, at a frequency of 3 rad/s, from an in an oscillating cone and plate viscometer, with an increasing amplitude. The type and distribution of the filler are indicated.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a system where nanometer-sized particles may be added to elastomer binders, to manipulate stiffness and viscosity of an aggregate of solids. This makes it easier and safer to mix solid formulations that cannot tolerate temperature increases that arise during the mixing, while also providing better mechanical properties for storage and subsequent operation. Normally these changes to the properties are mutually exclusive.

The compromise between the ease of mixing and the final properties was overcome by using nanoparticle-reinforced rubbers, in a two-phase mixture. This system may be engineered to have the low viscosity for processing, but also provide higher stiffness to resist void formation and crack growth that occurs during storage and service. This is accomplished by using a non-uniform distribution of particles, provided by mixing them separately in the two oligomers, which were then mixed together to make two phases. Because the mixing viscosity and final stiffness depend non-linearly on the particle size and distribution, this makes it possible to decouple the high-strain behavior in processing from the low-strain behavior in storage and use.

The material is made from a first polymer, a second polymer, and particles of a filler material. The first polymer and the second polymer are immiscible. For example, the first polymer may be a polyethylene glycol that is chain-extended with a diisocyanate, and the second polymer may be a polytetrahydrofuran chain-extended with the diisocyanate. The diisocyanate may be, for example, 1,6-diisocyanato hexane. Example particles include particles comprising silica or diamond, and they may have an average particle size of, for example, at most 100 nm.

The particles are combined with the first polymer, the second polymer, or both. The two polymers are then combined to form a composition comprising a continuous phase and a discontinuous phase embedded in the continuous phase. The first polymer is found in the continuous phase, and the second polymer is found in the discontinuous phase.

The discontinuous phase has a higher viscosity than the continuous phase. For example, the ratio of the viscosities may be at least 20:1.

The model two-phase system, consisting of chemically similar but incompatible polymers with different viscosities, with the nanoparticles confined to the higher viscosity phase, provides for independent engineering of the properties needed at high shear strains during processing, and the properties needed at low strains during storage and use. This behavior is general, and the binder can be modified to suit a particular application, using well-known methods available in polymer chemistry. The viscosity of the two-phase mixture is governed by the lower viscosity component, but the low strain properties of the final binder is governed by the high viscosity component. A polymer chemist familiar with the art may adjust the initial viscosities of the two polymers by changing their molecular weights, adding sidechains, adjusting the molecular weight distribution, etc., to achieve the desired mixing kinematics. The final modulus of the binder may be adjusted by the nanoparticle concentration, chemical, physical or ionic crosslinks, etc.

Any two incompatible polymers—and nearly all polymers are incompatible—may be used, and do not need be closely related. The type of nanoparticle filler selected will be governed their surface chemistry, floc size and structure, and particle size.

There are many applications of this technology, which can be sensitive to temperature rises during mixture should be avoided—metal mixtures for powder metallurgy, medicine formulation—any use in which solids are mixed and held together with a polymer binder.

The implementation described consists of a 50:50 mixture of polytetrahydrofuran (PTHF) and polyethylene glycol (PEG), mixed with either nano-silica or nano-diamond particles. The new binder system may make the mixing easier while also improving the mechanical reliability of the final mixture.

PEG (weight average molecular weight=400 Da) and PTHF (weight average molecular weight=2900 Da) were purchased from Sigma-Aldrich and used without further purification. Silica nanoparticles (diameter ˜12.5 nm), supplied by Nissan Chemicals, were suspended in 2-butanone (methyl ethyl ketone). The particles were functionalized with hydroxyl groups (5-8 OH groups per nm2). The oligomers were chain extended by reacting them with 1,6-diisocyanatohexane at 0.9 equivalents of isocyanate to hydroxyl in a 20 mL scintillation vial. The mixture was sealed and stirred at 80° C. for 21.5 hours.

Chain extended polymers incorporating SiO₂ nanoparticles were synthesized by adding the oligomers with 0.9 equivalents of isocyanate to hydroxyl and allowed to stir at 80° C. in a sealed 20 mL scintillation vial for 2 h. Upon which, the colloidal silica was added (10 or 20 phr) to the dissolved polymer, and stirred at 80° C. for a further 25 h. The 2-butanone solvent was removed by rotary evaporation and the polymer sample was heated under vacuum at 70° C. for several days to remove residual solvent. Finally, the two chain-extended polymers were mechanically mixed under vacuum, after the solvent had been removed.

Mechanical spectroscopy and steady-state shear flow measurements were carried out with an Anton-Paar MCR 502 rheometer, using a cone and plate fixture (either 25 mm and 0.978° cone angle, or 50 mm diameter and 1° cone angle). Prior to acquisition, initial amplitude and frequency sweeps were carried out to remove the Mullins effect (Chazeau et al., Polymer Composites 21(2), 202-222 (2000)); the subsequent data shown here was reproducible. All measurements were done at 45° C.

Gel permeation chromatography was performed on a Waters GPC was performed on a Waters e2695 separations module equipped with a Waters 2414 refractive index detector. The mobile phase was THF with a flow rate of 1 mL/min, and samples were dissolved to a concentration of 5 mg/mL. The molecular weights of the chain-extended polymers were broadly distributed; the peak Mₚ, weight-average M_{w}, and number-average Mn molecular weights, and viscosity η, are given in Table 1. Molecular weight and polydispersity were calculated from a calibration curve based on narrow polystyrene standards.

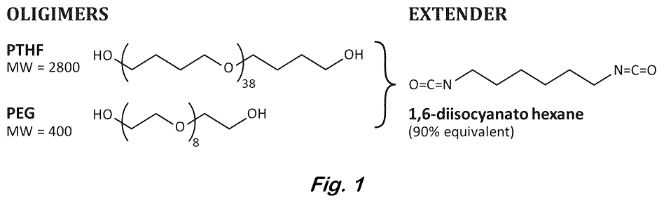

The backbones of the two polymers selected for this implementation are quite similar (FIG. 1), but with PEG having twice as many ether linkages as PTHF, per equivalent molecular weight. The PEG and PTHF oligomers were chain extended by reacting with 1,6 diisocyanatohexane at 0.9 equivalents of isocyanate to hydroxyl. The molecular weights and viscosities of the polymers, resulting from the chain extension reactions, are shown in Table 1.

TABLE 1
Peak Mₚ, weight-average M_{w}, and number-average
Mₙ molecular weights, and viscosities η, of polymers
following chain extension. Molecular weights were
measured by gel-permeation chromatography

| Polymer | Mₚ (Da) | M_{w}/Mₙ | Extension Factor | η (Pa · s) |
|---|---|---|---|---|
| PTHF | 66,858 | 1.45 | 22.5 | 1000 |
| PEG | 5,432 | 1.84 | 9.6 | 32 |

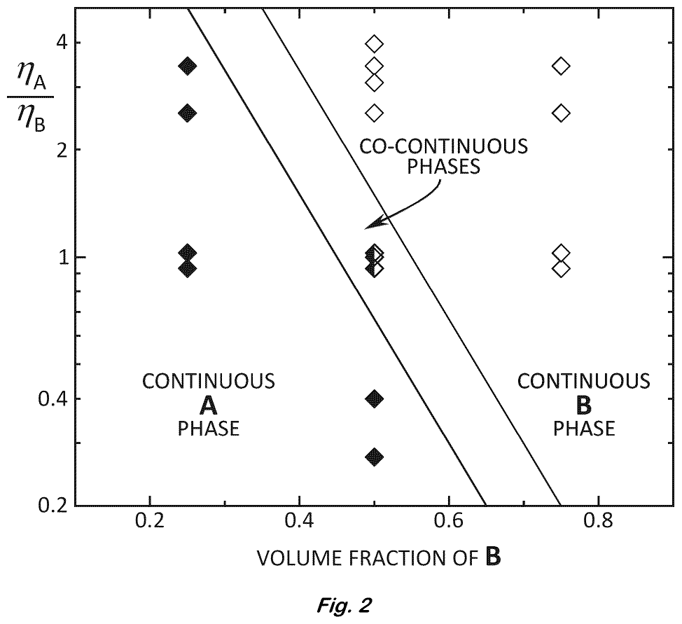

A 50:50 ratio of the two polymers was selected. When they are mixed, the microstructure that forms depends on the volume and viscosity ratios of the components, shown in FIG. 2. From Table 1, the viscosity ratio of the two polymers after their chain extension reactions is

$$\frac{{η}_{PTHF}}{{η}_{PEG}} = 31$$

When the polymers have an equal volume ratio but a quite different viscosity, the shearing during mixing will break up the higher viscosity domain first, and the lower viscosity domain will encapsulate the broken-up higher viscosity domain. Hence, the discontinuous phase is expected to be the higher viscosity PTHF, and the continuous phase the lower viscosity PEG.

Two different nanoparticles were mixed with the polymers: silica and diamond. Table 2 summarizes the six systems that were explored—of the two nanoparticle fillers, there were three particle distributions, but with the overall particle concentration kept constant: (1) all particles in PTHF; (2) particles evenly distributed; and (3) all particles in PEG. Because the diamond-filled systems were much more sensitive to the amount of filler than to silica, the overall filler concentration of those systems was reduced.

TABLE 2

| | | Filler Concentration | | | |
|---|---|---|---|---|---|
| Nano- | Diameter | (wt %) | | | |
| filler | (nm) | Overall | PTHF | PEG | Nomenclature |
| Silica | 10-15 | 10 | 20 | 0 | PTHF S200 - PEG |
| | | | 10 | 10 | PTHF S100 - PEG S100 |
| | | | 0 | 20 | PTHF - PEG S200 |
| Dia- | 10-20 | 2.5 | 5.0 | 0 | PTHF D050 - PEG |
| mond | | | 2.5 | 2.5 | PTHF D025 - PEG D025 |
| | | | 0 | 5.0 | PTHF - PEG D050 |

The silica particles were received as a stabilized colloid in 2-butanone. They were surface functionalized with hydroxyl groups, so that hydrogen bonds will form between the ether oxygen on the backbone and the silica on the surface of the nanoparticles, locking the silica to the polymer phase in which it was added. The diamond particles were received dry, with the particles agglomerated in 50-100 um flocs. The diamond particles were used as received. A fter ultrasonic mixing into 2-butanone, light scattering measurements indicated that the particle size of the diamond filler was on the order of 100-1000 nm. It is expected that for both fillers, the nanoparticles are fixed to the polymer into which they were mixed, and do not appreciably migrate to the other polymer phase.

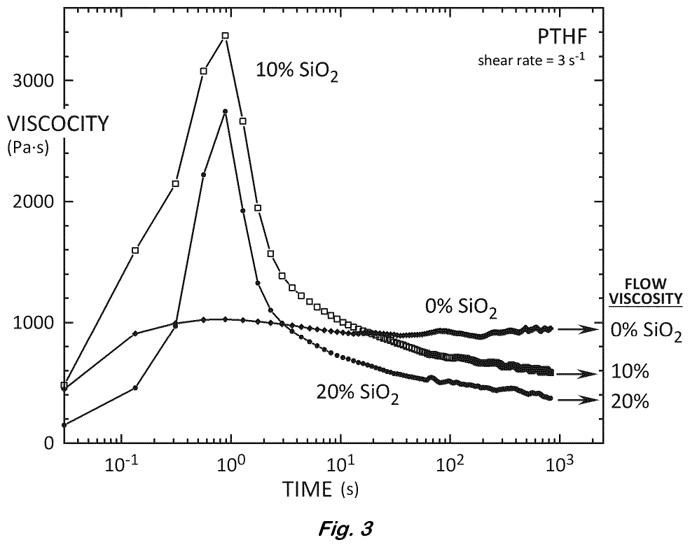

FIG. 3 shows the effect of mixing SiO₂ nanoparticles into single-phase PTHF (no PEG). The figure plots the viscosity during steady-state shearing: for the neat PTHF, the viscosity was nearly constant—typical Newtonian behavior. For the nanoparticle-filled systems, there is a peak viscosity enhancement at 1 s, is the well-known Payne effect, where the filler causes a temporary increase in stiffness due to particle-particle interactions. The effect is strongly non-linear: adding 10 wt % silica produced a larger peak viscosity enhancement than adding 20 wt %. Further, the flow viscosity (at long times) is inversely related to the SiO₂ concentration. This is anomalous; generally, adding more particles increases the viscoelastic stiffness.

For single-phase PEG the effects are similar. This system also demonstrated anomalous flow viscosity, that was inversely related to the SiO₂ filler concentration.

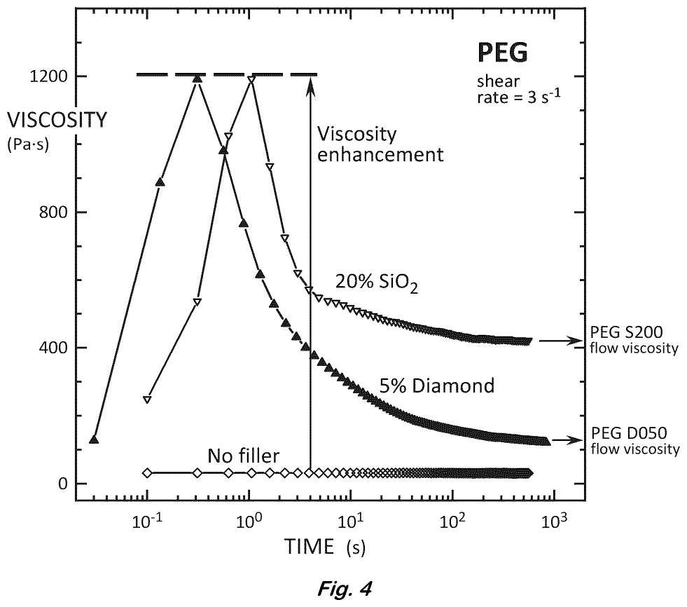

The viscosity peak enhancement from diamond nanoparticles, in both the single phase PTHF and PEG systems, was far more potent. FIG. 4 shows the steady state shearing viscosity of PEG systems with no filler, 5 wt % diamond, and 20 wt % silica. The viscosity of neat PEG was constant, similar to the Newtonian neat PTHF in FIG. 3. The two filled systems in FIG. 4 have viscosity enhancement, to approximately the same peak magnitude. At long times (i.e., steady flow) the diamond-filled system had roughly one-quarter of the viscosity as the silica system. Compared to the silica-filled system, the diamond filler was four times more effective at generating the Payne viscosity peak, but yet gave lower steady flow viscosity. This will decrease the required torque, and also generate less heat, during mixing.

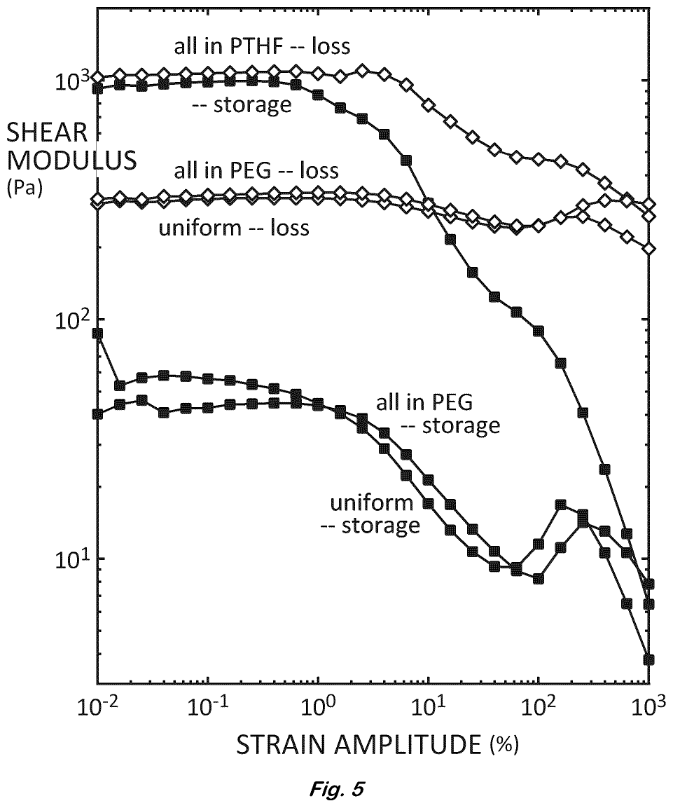

For two-phase 50:50 polymer mixtures filled with SiO₂, FIG. 5 plots the storage and loss moduli during an oscillating strain amplitude sweep. The figure plots results from three different particle distributions, which all have a total of 10 wt % silica: (1) all particles in PTHF; (2) 50% in PTHF and 50% in PEG; or (3) all particles in PEG. The latter two show nearly the same behavior, with nearly steady loss modulus, which at low strain is about 40 times that of the storage modulus. On the other hand, the all-in-PTHF system is quite different. At low strain, the loss modulus is five times that of the PEG and uniform systems, with the storage and loss moduli being approximately equal, which is ca. 200 times higher than the storage modulus of the other systems. As the strain amplitude is increased, both the storage and loss decrease, approaching that of the 50-50 and all-in-PEG systems. When the silica is put in only PTHF, the system has a much higher stiffness at low strain but will flow as easily at high strain. This would both make mixing easier and improve resistance to void formation, both of which suppress crack formation and growth during service.

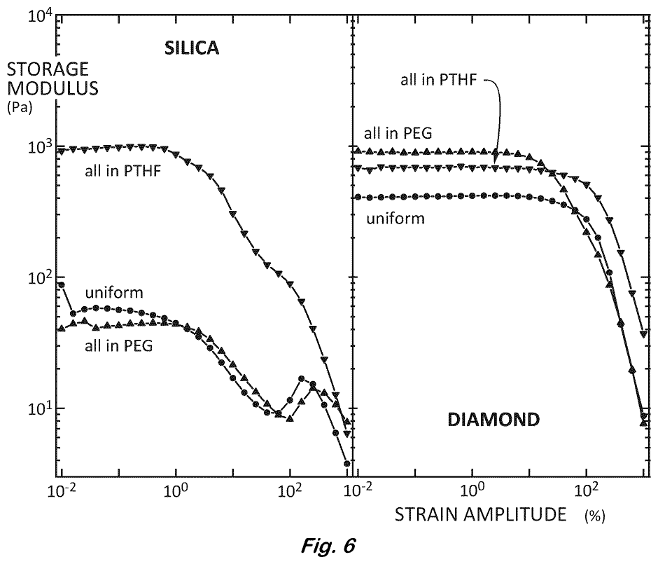

FIG. 6 summarizes the behavior of both fillers in the phase-separated system. It shows a strain amplitude sweep of the storage moduli, with silica and diamond nano-fillers, comparing six separate PTHF-PEG compositions: for each filler type, the distribution was varied between the phases, with the overall concentration kept constant.

In the description above, the presumed desired properties were low viscosity during processing, but high stiffness during storage and use. However, there may be other applications that require the opposite, i.e., high viscosity for mixing, but low stiffness during service. By using a phase-separated binder mixture, with differing amounts of nanoparticles in the two phases, the technology separates processing from the storage and use, to enable better performance in both.

Many modifications and variations are possible in light of the above teachings. It is therefore to be understood that the claimed subject matter may be practiced otherwise than as specifically described. A ny reference to claim elements in the singular, e.g., using the articles “a”, “an”, “the”, or “said” is not construed as limiting the element to the singular.

What is claimed is:

1. A composition comprising:
a continuous phase comprising a first polymer;
a discontinuous phase comprising a second polymer embedded in the continuous phase; and
particles of a filler material in the continuous phase, the discontinuous phase, or both;
wherein the first polymer and the second polymer are immiscible;
wherein the continuous phase has a first viscosity; and
wherein the discontinuous phase has a second viscosity higher than the first viscosity.

2. The composition of claim 1, wherein the ratio of the second viscosity to the first viscosity is at least 20:1.

3. The composition of claim 1;
wherein the first polymer is a polyethylene glycol chain-extended with a diisocyanate; and
wherein the second polymer is a polytetrahydrofuran chain-extended with the diisocyanate.

4. The composition of claim 3, wherein the diisocyanate is 1,6-diisocyanato hexane.

5. The composition of claim 1, wherein the particles have an average particle size of at most 100 nm.

6. The composition of claim 1, wherein the particles comprise silica.

7. The composition of claim 1, wherein the particles comprise diamond.

8. A method comprising:
providing a first polymer, a second polymer, and particles of a filler material;
combining the first polymer, the second polymer, or both with the particles; and
mixing the first polymer and the second polymer to form a composition comprising:
a continuous phase comprising the first polymer;
a discontinuous phase comprising the second polymer embedded in the continuous phase; and t
he particles in the continuous phase, the discontinuous phase, or both;
wherein the first polymer and the second polymer are immiscible;
wherein the continuous phase has a first viscosity; and
wherein the discontinuous phase has a second viscosity higher than the first viscosity.

9. The method of claim 8, wherein the ratio of the second viscosity to the first viscosity is at least 20:1.

10. The method of claim 8;
wherein the first polymer is a polyethylene glycol chain-extended with a diisocyanate; and
wherein the second polymer is a polytetrahydrofuran chain-extended with the diisocyanate.

11. The method of claim 10, wherein the diisocyanate is 1,6-diisocyanato hexane.

12. The method of claim 8, wherein the particles have an average particle size of at most 100 nm.

13. The method of claim 8, wherein the particles comprise silica.

14. The method of claim 8, wherein the particles comprise diamond.
